(19) United States
(12) Patent Application Publication
(10) Pub. No.: US 2018/0357685 A1
(43) Pub. Date: Dec. 13, 2018

(54) MANAGEMENT APPARATUS AND NON-TRANSITORY COMPUTER READABLE MEDIUM

(71) Applicant: FUJI XEROX CO., LTD., Tokyo (JP)

(72) Inventor: Hironori TANAKA, Kanagawa (JP)

(73) Assignee: FUJI XEROX CO., LTD., Tokyo (JP)

(21) Appl. No.: 15/989,616

(22) Filed: May 25, 2018

(30) Foreign Application Priority Data
Jun. 8, 2017 (JP) 2017-113429

(51) Int. Cl. G06Q 30/02; G06Q 50/04

(52) U.S. Cl. CPC G06Q 30/0283; G06Q 50/04

(57) ABSTRACT

A management apparatus includes a first setting unit, a second setting unit, and a calculation unit. The first setting unit sets a unit price to be charged per unit usage amount for a material used in a forming apparatus. The second setting unit sets, for the material, a basic fee to be charged regardless of a usage amount. The calculation unit calculates a cost to be charged for use of the material by using the unit price and the basic fee.

### CROSS-REFERENCE TO RELATED APPLICATIONS

This application is based on and claims priority under 35 USC 119 from Japanese Patent Application No. 2017-113429 filed Jun. 8, 2017.

### BACKGROUND

### (i) Technical Field

The present invention relates to a management apparatus and a non-transitory computer readable medium.

### (ii) Related Art

Currently, three-dimensional (3D) model forming apparatuses called 3D printers are being increasingly used.

Meanwhile, for image forming apparatuses that form images on, for example, sheets (hereinafter called two-dimensional (2D) printers to distinguish these printers from 3D printers), an apparatus or a system that performs management including charge management for usage fees are available.

### SUMMARY

According to an aspect of the invention, there is provided a management apparatus including a first setting unit, a second setting unit, and a calculation unit. The first setting unit sets a unit price to be charged per unit usage amount for a material used in a forming apparatus. The second setting unit sets, for the material, a basic fee to be charged regardless of a usage amount. The calculation unit calculates a cost to be charged for use of the material by using the unit price and the basic fee.

### BRIEF DESCRIPTION OF THE DRAWINGS

An exemplary embodiment of the present invention will be described in detail based on the following figures, wherein:

FIG. 1 is a diagram illustrating a print system including a management server that corresponds to a management apparatus according to an exemplary embodiment of the present invention;

FIG. 2 is a structure diagram illustrating an overall structure of a 3D printer;

FIG. 3 is a functional block diagram illustrating a functional configuration of the management server; and

FIG. 4 is a diagram illustrating a structure of a unit price management table.

### DETAILED DESCRIPTION

Hereinafter, an exemplary embodiment of the present invention will be descried with reference to the drawings.

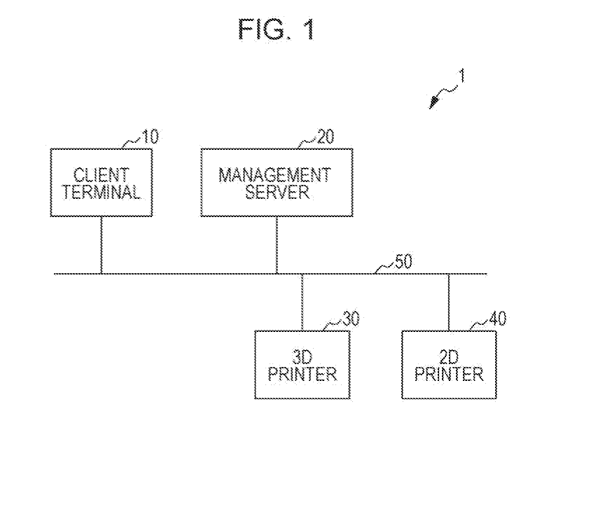

FIG. 1 is a diagram illustrating a print system including a management server that corresponds to a management apparatus according to an exemplary embodiment of the present invention.

In the example illustrated in FIG. 1, the management server manages both a 3D printer and a 2D printer; however, the management apparatus according to an exemplary embodiment of the present invention may manage only a 3D printer or may manage only a 2D printer.

A print system 1 according to this exemplary embodiment includes a client terminal 10, a management server 20, a 3D printer 30, and a 2D printer 40 as system elements, and the system elements are connected to one another over a communication network, such as a local area network (LAN) 50.

The client terminal 10 is a terminal operated by a user of the print system 1. As the hardware of the client terminal 10, for example, a personal computer is used. The user operates the client terminal 10 to create data representing a 3D model or an image that the user wants to output (print) using the 3D printer 30 or the 2D printer 40 (hereinafter, such data is collectively referred to as print data) or to obtain print data that is available. Then, the user transmits the print data from the client terminal 10 to the management server 20 to thereby instruct the 3D printer 30 to form a 3D model (hereinafter, this forming is referred to as model forming) or instruct the 2D printer 40 to form an image (hereinafter, this forming is referred to as image forming). An output product obtained as a result of the model forming or the image forming is taken from the 3D printer 30 or the 2D printer 40 by the user.

The management server 20 corresponds to the management apparatus according to an exemplary embodiment of the present invention and manages the 3D printer 30 and the 2D printer 40. As the hardware of the management server 20 according to this exemplary embodiment, a general-purpose server computer that includes a central processing unit (CPU) and a hard disk drive and that further includes semiconductor storage devices, such as a random access memory (RAM) and a read-only memory (ROM), is used. The functions of the management apparatus according to an exemplary embodiment of the present invention are implemented when a management program according to an exemplary embodiment of the present invention is installed in the server computer and executed. The management server 20 manages various matters in the print system 1. In this exemplary embodiment, the management server 20 performs, for example, management of users' privileges for use and users' authentication, output management of print data for the 3D printer 30 and the 2D printer 40, and charge management for use of the print system 1 by users.

The 2D printer 40 is a printer that records an image (which may be a text image) on a recording material, such as a sheet. As recording materials used in the 2D printer 40 according to this exemplary embodiment, plural types of recording materials, such as recording materials of different sizes, such as A4 size and A3 size, recoding materials of different paper qualities, such as plain paper, coated paper, and plastic paper, and recording materials of different thicknesses, are used depending on the purpose.

The 3D printer 30 is a printer that forms layers of a 3D model one by one sequentially on the basis of print data that represents the 3D model. As the 3D printer 30, a printer using a technique, such as stereolithography, selective laser sintering, fused deposition modeling, binder jetting, or material jetting, may be used. In this exemplary embodiment, it is assumed that, for example, a fused deposition modeling technique is used for the 3D printer 30, In the 3D printer 30 according to this exemplary embodiment, it is assumed that plural materials are selectively used and that selection from among the materials and switching between the materials are specified in print data.

The 3D printer 30 is further described below.

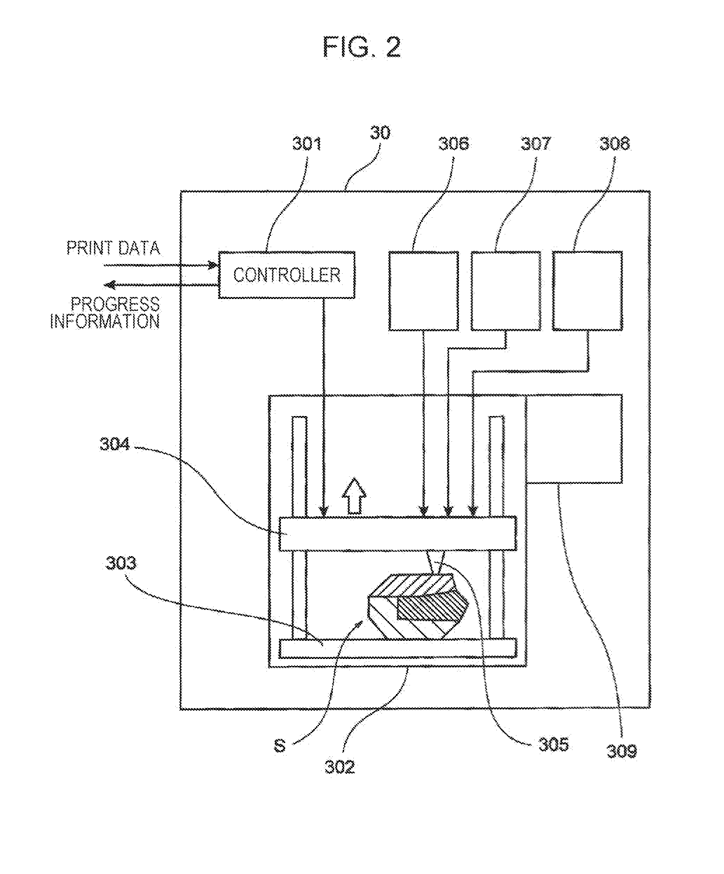

FIG. 2 is a structure diagram illustrating an overall structure of the 3D printer 30.

The 3D printer 30 includes a controller 301 and a forming unit 302. To the controller 301, print data is input.

The forming unit 302 includes a fixed stage 303 and a movable head 304. The movable head 304 is equipped with a nozzle 305. A material is discharged through the nozzle 305 while the movable head 304 moves parallel to the fixed stage 303, which is a flat stage, to thereby form one layer of a 3D model S. The movable head 304 moves in a direction so as to move away from the fixed stage 303, thereby stacking layers sequentially and forming the 3D model S.

The operations of the movable head 304 are controlled by the controller 301 in accordance with print data. The controller 301 creates and outputs progress information indicating progress made in forming of the 3D model

To the movable head 304, plural types of materials that are used to form the 3D model S are supplied from plural material supply units 306, 307, and 308. Selection from among the materials and switching between the materials are performed in the movable head 304. Materials for model forming are specifically linear materials called filaments. Each of the materials is fused in the movable head 304 from the front end toward the rear end and discharged through the nozzle 305. As the materials for model forming, plural types of materials are often used for one 3D model S. Usually, materials of different types have significantly different unit prices.

To the forming unit 302, a maintenance device 309 is attached. This exemplary embodiment assumes that the maintenance of the nozzle 305 is automatically performed by the maintenance device 309, The maintenance of the nozzle 305 is performed when, for example, the material is switched,

The functions of the management server 20 illustrated in FIG. 1 are described in detail below.

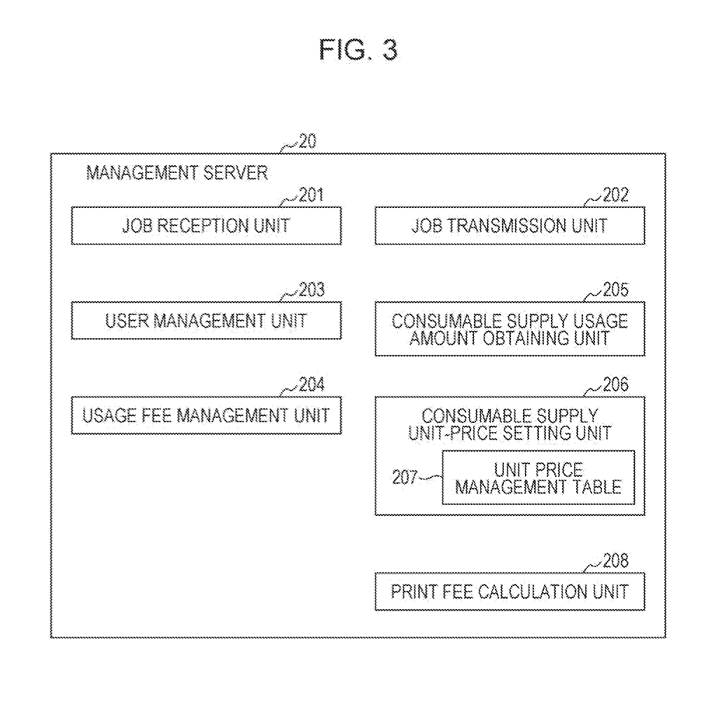

FIG. 3 is a functional block diagram illustrating a functional configuration of the management server 20.

FIG. 3 illustrates a functional configuration of some of the functions of the management server 20. As described above, in this exemplary embodiment, the functions of the management apparatus according to an exemplary embodiment of the present invention are implemented when the management program according to an exemplary embodiment of the present invention is installed in a general-purpose server computer and executed. Therefore, the functional block diagram in FIG. 3 also illustrates the program configuration of the management program according to an exemplary embodiment.

The management server 20 includes a job reception unit 201, a job transmission unit 202, a user management unit 203, a usage fee management unit 204, a consumable supply usage amount obtaining unit 205, a consumable supply unit-price setting unit 206, and a print fee calculation unit 208. The consumable supply unit-price setting unit 206 includes a unit price management table 207.

The job reception unit 201 receives print data from the client terminal 10 illustrated in FIG. 1 as a job.

The job transmission unit 202 transmits print data to the 3D printer 30 or the 2D printer 40 illustrated in FIG. 1 as a job.

The user management unit 203 manages users' privileges for use and users' authentication.

The usage fee management unit 204 manages usage fees on a per user basis and centrally manages usage fees of the 3D printer 30 and the 2D printer 40 illustrated in FIG. 1.

The consumable supply usage amount obtaining unit 205 obtains the usage amounts of consumable supplies, such as materials used in model forming by the 3D printer 30 and sheets used in the 2D printer 40, from the 3D printer 30 and the 2D printer 40. In the case of the 3D printer 30, it is assumed that the progress information described above includes information about the usage amounts of consumable supplies.

The consumable supply unit-price setting unit 206 sets a unit price for each type of consumable supply and stores the unit price in the unit price management table 207. The unit price is set in accordance with a setting operation performed by the administrator of the print system 1. The consumable supply unit-price setting unit 206 also sets, for each type of consumable supply, a basic fee independent of the usage amount in accordance with an operation by the administrator and stores the basic fee in the unit price management table 207. The consumable supply unit-price setting unit 206 corresponds to an example of a unit that functions as a first setting unit and a second setting unit according to an exemplary embodiment of the present invention.

The print fee calculation unit 208 calculates, for each job, a print fee, which is the usage fee of the print system 1, on the basis of the usage amounts obtained by the consumable supply usage amount obtaining unit 205 and the unit prices set by the consumable supply unit-price setting unit 206, and inputs the print fee to the usage fee management unit 204. The print fee calculation unit 208 corresponds to an example of a calculation unit according to an exemplary embodiment of the present invention.

The unit price management table 207 is described in detail below.

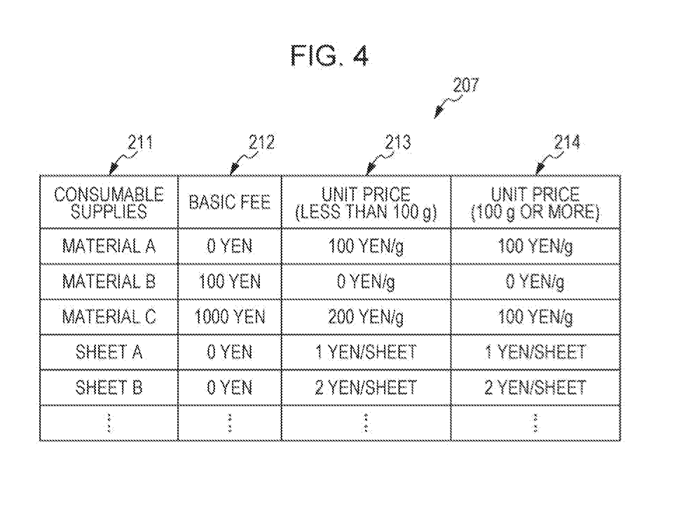

FIG. 4 is a diagram illustrating a structure of the unit price management table 207.

The unit price management table 207 includes a consumable supply column 211, a basic fee column 212, a first unit price column 213, and a second unit price column 214.

In the consumable supply column 211, the types of materials that are used in the 3D printer 30 illustrated in FIG. 1 and FIG. 2 and the types of sheets used in the 2D printer 40 illustrated in FIG. 1 are included.

In the basic fee column 212, for each consumable supply, a basic fee that is charged regardless of the usage amount in the case where the consumable supply is used is included. As a basic fee included in the basic fee column 212, 0 yen may be set. Unlike in the case of the 2D printer 40, in the case of the 3D printer 30, a fixed cost, such as a nozzle cleaning cost, independent of the usage amount may be incurred when consumable supplies are used. As a usage fee corresponding to such a cost, a basic fee is set to thereby implement appropriate charging.

In the first unit price column 213, unit prices for a usage amount range of less than 100 g are included. In the second unit price column 214, unit prices for a usage amount range of: 100g or more are included. For example, the purchase unit price of a material A is high, and therefore, a unit price of 100 yen per gram is set regardless of the usage amount range. For example, the purchase unit price of a material B is low, and therefore, 100 yen per use is set as the basic fee corresponding to a fixed cost, as a nozzle cleaning cost, and 0 yen is set as the unit price based on the usage amount. For example, a material C is a material for which nozzle cleaning is more difficult than nozzle cleaning for the other materials, and therefore, 1000 yen per use is set as the basic fee, and the unit price for a smaller usage amount in the first unit price column 213 is made higher than the unit price for a larger usage amount in the second unit price column 214 to thereby implement a volume discount.

In the unit price management table 207, settings related to sheets used in the 2D printer 40 are also included as well as the settings related to materials used in the 3D printer 30. Accordingly, in the print system 1, the usage fees of the 3D printer 30 and the 2D printer 40 are centrally set and stored, and fee calculations are centrally performed.

In the print fee calculation unlit 208 illustrated in FIG. 3, the print fees for respective consumable supplies that have been used are calculated and added up. The print fee for each consumable supply is calculated by adding the product of the usage amount and the unit price to the basic fee. That is, in the case of, example, the settings as illustrated in FIG. 4, the print fee for the 3D printer 30 is calculated by using the following expression.

Print fee=Usage amount (g) of material A×100 yen+Number of times material B is used×100 yen+Number of times material C is used×1000 yen+Usage amount (g) of material C (for an amount up to 100 g)×200 yen+Usage amount (g) of material C (for an excess amount above 100 g)×100 yen

Accordingly, the usage fee of the 3D printer 30 and the usage fee of the 2D printer 40 are appropriately calculated, and appropriate charging is implemented.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A management apparatus comprising:
a first setting unit that sets a unit price to be charged per unit usage amount for a material used in a forming apparatus;
a second setting unit that sets, for the material, a basic fee to be charged regardless of a usage amount; and
a calculation unit that calculates a cost to be charged for use of the material by using the unit price and the basic fee.

2. The management apparatus according to claim 1, wherein
the first setting unit is capable of setting unit prices that are respectively associated with a plurality of ranges of the usage amount of the material,

3. The management apparatus according to claim 2, wherein
among the unit prices respectively associated with the plurality of ranges, a unit price associated with a range that corresponds to a larger usage amount of the material is made lower.

4. The management apparatus according to claim 1, further comprising
a setting memory that stores a management table, the management table including the unit price and the basic fee that are set for each type of the material and further including a unit price to be charged per unit usage amount of a recording material used in a print apparatus, the unit price of the recording material being set as a unit price of one type of the material, wherein
the calculation unit calculates both the cost to be charged for use of the material and a cost to be charged for use of the recording material by using a single calculation formula.

5. The management apparatus according to claim 2, further comprising
a setting memory that stores a management table, the management table including the unit price and the basic fee that are set for each type of the material and further including a unit price to be charged per unit usage amount of a recording material used in a print apparatus, the unit price of the recording material being set as a unit price of one type of the material, wherein
the calculation unit calculates both the cost to be charged for use of the material and a cost to be charged for use of the recording material by using a single calculation formula.

6. The management apparatus according to claim 3, further comprising
a setting memory that stores a management table, the management table including the unit price and the basic fee that are set for each type of the material and further including a unit price to be charged per unit usage amount of a recording material used in a print apparatus, the unit price of the recording material being set as a unit price of one type of the material, wherein
the calculation unit calculates both the cost to be charged for use of the material and a cost to be charged for use of the recording material by using a single calculation formula.

7. The management apparatus according to claim 4, wherein
for the recording material, the basic fee is set to zero.

8. The management apparatus according to claim 5, wherein
for the recording material, the basic fee is set to zero.

9. The management apparatus according to claim 6, wherein
for the recording material, the basic fee is set to zero.

10. A non-transitory computer readable medium storing a program causing a computer to execute a process for management, the process comprising:
setting a unit price to be charged per unit usage amount for a material used in a forming apparatus;
setting, for the material, a basic fee to be charged regardless of a usage amount; and
calculating a cost to be charged for use of the material by using the unit price and the basic fee.
